(19) United States
(12) Patent Application Publication
(10) Pub. No.: US 2017/0164430 A1
(43) Pub. Date: Jun. 8, 2017

(54) MICROWAVE OVEN WITH STEAM GENERATING DEVICE

(71) Applicant: WHIRLPOOL CORPORATION, BENTON HARBOR, MI (US)

(72) Inventors: Bella Lv, Shenzhen (CN); Joelex Fan, Benton Harbor, MI (US)

(73) Assignee: WHIRLPOOL CORPORATION, BENTON HARBOR, MI (US)

(21) Appl. No.: 15/316,601

(22) PCT Filed: Jun. 6, 2014
(86) PCT No.: PCT/CN2014/079343

§ 371 Date: Dec. 6, 2016

(51) Int. Cl. H05B 6/64; H05B 6/70

(52) U.S. Cl. CPC H05B 6/6479; H05B 6/707

(57) ABSTRACT

A steam generating device for use with a microwave oven includes a casing made of a material that is impenetrable to microwave energy. The casing is removably coupled to a sidewall of a cooking cavity of the microwave oven, such that the casing fully covers a microwave inlet configured to channel microwave energy to the cooking cavity. A water tank, having an open top and a cavity configured to hold a volume of water, is received in the casing and provides steam as the volume of water is heated by the microwaves of the microwave oven.

### BACKGROUND

Generally, a microwave oven is an electrically powered apparatus which uses high frequency electromagnetic waves to heat or cook a food item within a cooking cavity of the microwave oven. The high frequency electromagnetic waves “microwaves”, are generally generated from a magnetron disposed adjacent to the cooking cavity. In an effort to provide various cooking methods, present day microwave ovens may include a steam generating system which are generally complex and expensive features included with the microwave oven. Often times, such steam generating devices include a separate heating source and are made to be permanent fixtures of the microwave oven, such that cleaning and maintenance are an issue. Thus, it is desirable to have a microwave oven with a steam generating device that is modular in nature and configured to work in a conventional microwave oven.

### SUMMARY

One aspect of the present invention includes a steam generating device for use with a microwave oven, wherein the microwave oven includes a housing having a cooking cavity and a component compartment separated by a sidewall of the cooking cavity. A microwave generating device is disposed in the component compartment and configured to irradiate microwaves into the cooking cavity through a microwave inlet disposed on the sidewall of the cooking cavity. The steam generating device includes a casing made of a material that is impenetrable to microwave energy. The casing is removably coupled to the sidewall of the cooking cavity over the microwave inlet, such that the casing fully covers the microwave inlet. A water tank having an open top and a cavity configured to hold a volume of water is received in the casing.

Another aspect of the present invention includes a microwave oven including a cooking cavity having a sidewall with a microwave inlet disposed thereon. The microwave oven further includes a microwave generating device for selectively supplying microwaves to the cooking cavity through the microwave inlet. A steam generating device is configured to introduce steam into the cooking cavity. The steam generating device includes a water tank received in a microwave impenetrable casing having an open side. The casing is removably coupled to the sidewall of the cooking cavity and further includes a steam outlet opening into the cooking cavity. The casing covers the microwave inlet as coupled to the sidewall of the cooking cavity.

Yet another aspect of the present invention includes a microwave oven having a cooking cavity with a sidewall which includes a microwave inlet disposed thereon. A microwave generating device is included for selectively supplying microwaves to the cooking cavity through the microwave inlet. A steam generating device is further included for introducing steam into the cooking cavity. The steam generating device includes a water tank received in a microwave impenetrable casing. The casing is removably coupled to the sidewall of the cooking cavity over the microwave inlet, such that the casing blocks the microwave inlet from supplying microwaves to the cooking cavity. The steam generating device further includes a pressure control apparatus configured to control the introduction of steam into the cooking cavity as dictated by a threshold pressure of steam being realized in the casing.

These and other aspects, objects, and features of the present concept will be understood and appreciated by those skilled in the art upon studying the following specification, claims, and appended drawings.

### BRIEF DESCRIPTION OF THE DRAWINGS

In the drawings:

FIG. 1 is a top perspective view of a microwave oven according to an embodiment of the present concept;

FIG. 2 is an exploded top perspective view of the microwave oven of FIG. 1, having a steam generating device;

FIG. 3A is a top perspective view of the assembled microwave oven of FIG. 2;

FIG. 3B is a top perspective view of the microwave oven of FIG. 3A;

FIG. 4 is a top perspective view of the microwave oven of FIG. 1 having a steam generating device which includes a microwave outlet; and

FIG. 5 is a top perspective view of a microwave oven of another embodiment.

### DETAILED DESCRIPTION OF EMBODIMENTS

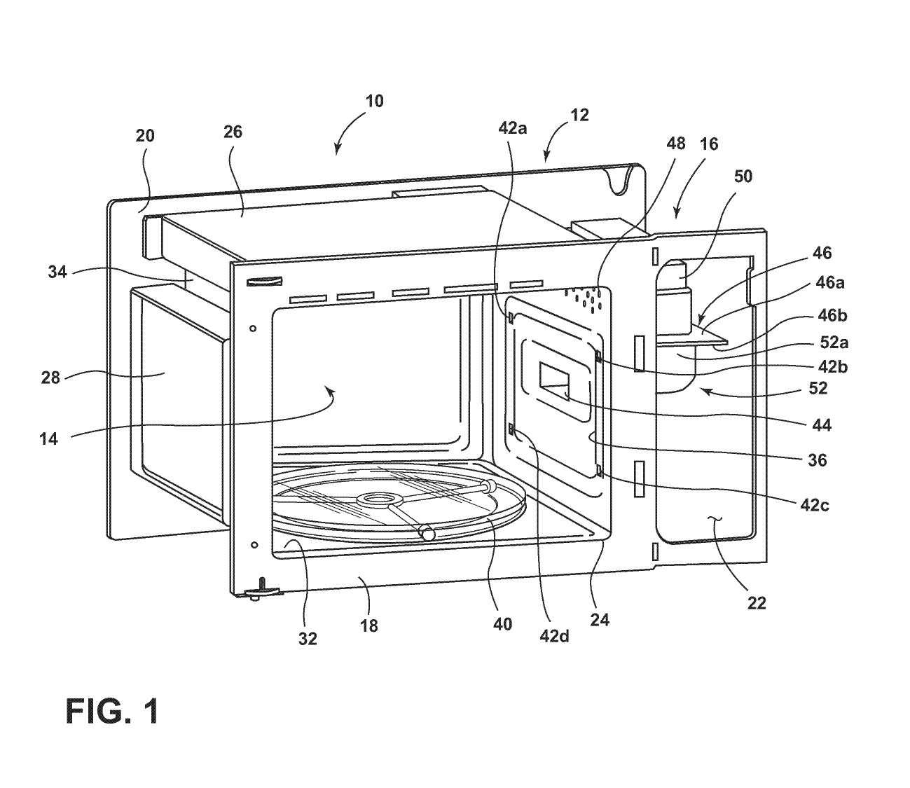

For purposes of description herein, the terms “upper,” “lower,” “right,” “left,” “rear,” “front,” “vertical,” “horizontal,” and derivatives thereof shall relate to the present concept as oriented in FIG. 1. However, it is to be understood that the present concept may assume various alternative orientations, except where expressly specified to the contrary. It is also to be understood that the specific devices and processes illustrated in the attached drawings, and described in the following specification are simply exemplary embodiments of the present concept defined in the appended claims. Hence, specific dimensions and other physical characteristics relating to the embodiments disclosed herein are not to be considered as limiting, unless the claims expressly state otherwise.

Referring now to FIG. 1, the reference numeral 10 generally designates a microwave oven according to an embodiment of the present concept. The microwave oven 10 includes a housing or body 12 having a cooking cavity 14 disposed therein. A component compartment 16 is further disposed within the housing 12 and is separately defined from the cooking cavity 14. The cooking cavity 14 is configured to receive a food item to be cooked therein. The component compartment 16 is configured to receive various electrical components and structures of the microwave oven 10 for operating the microwave oven 10 in various functional modes. As further shown in FIG. 1, the microwave oven 10 includes front and rear panels 18, 20 which are spaced apart to define opposite sides of the housing 12. The front panel 18 includes a mounting aperture 22 which is generally used to mount a user interface therein. It is noted that the microwave oven 10 shown in FIG. 1, does not include an outer housing which is generally known in the art.

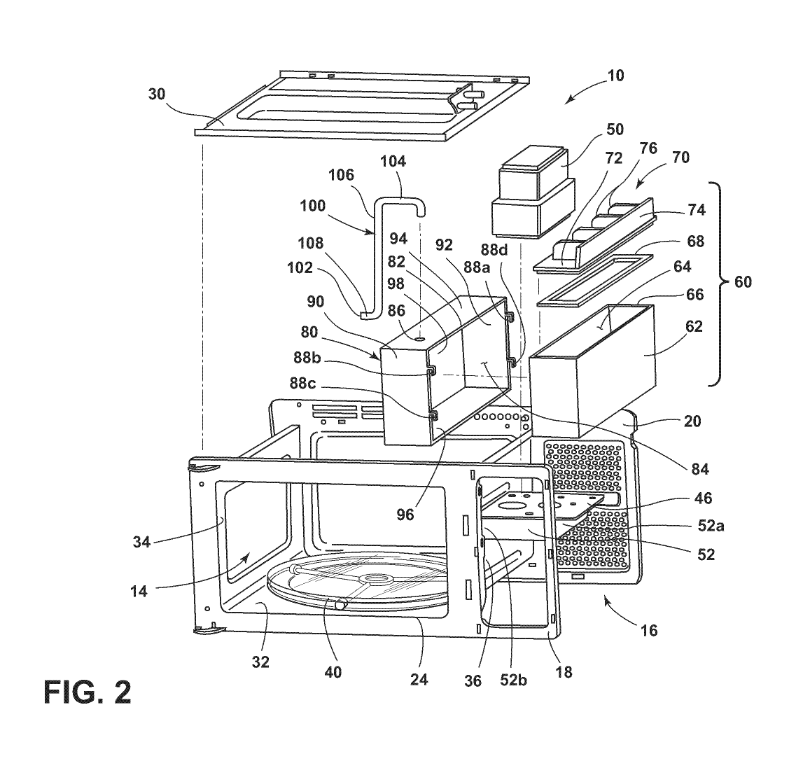

Referring now to FIGS. 1 and 2, the cooking cavity 14 includes a top wall 30, a bottom wall 32, and sidewalls 34, 36 which cooperate with the rear panel 20 to define a generally rectangular cooking cavity 14. Access to the cooking cavity 14 is provided through access aperture 24 disposed on the front panel 18. The access aperture 24 is configured to be selectively opened and closed by a door, which is not shown, that is generally pivotally mounted to the front panel 18. When the door is in the closed position, the cooking cavity 14 is sealed for cooking a food item placed therein. As best shown in FIG. 1, air channels 26, 28 are disposed on the top wall 30 and sidewall 34, respectively. A cooking tray 40 is rotatably mounted on the bottom wall 32 of the cooking cavity 14, and is configured to receive a food item thereon for rotation within the cooking cavity 14 during a cooking procedure.

As best shown in FIG. 1, sidewall 36 defines a divider which separates the cooking cavity 14 and the component compartment 16. Sidewall 36 includes a plurality of mounting apertures 42a-42d for mounting a steam generating device thereto, as further described below. Sidewall 36 also includes a microwave inlet 44 which, in FIG. 1, is generally centrally disposed on sidewall 36. A mounting plate 46 is shown coupled to sidewall 36 which extends outwardly from sidewall 36 into the component compartment 16. As further shown in FIG. 1, a magnetron 50 is disposed on an upper side 46a of mounting plate 46, and a waveguide 52 is coupled to an underside 46b of mounting plate 46. In operation, the magnetron 50 is configured to provide high-frequency electromagnetic waves, microwaves, for use in cooking a food item disposed in the cooking cavity 14. In this way, the magnetron 50 defines a microwave generating device. The waveguide 52 is in communication with the magnetron 50 through the mounting plate 46 at a first end 52a. The waveguide 52 is further in communication with the microwave inlet 44 at a second end 52b, as further described below. In this way, the waveguide 52 is configured to channel electromagnetic energy provided by the magnetron 50 to the cooking cavity 14 for cooking a food item during a cooking procedure. Thus, the magnetron 50 irradiates microwaves into the cooking cavity 14 via the waveguide 52 and microwave inlet 44. In the embodiment shown in FIG. 1, microwaves enter the cooking cavity 14 exclusively through microwave inlet 44. As further shown in FIG. 1, sidewall 36 includes vent holes 48 which are configured to ventilate the cooking cavity 14 as necessary during use. When a food item is placed in cooking cavity 14 and the appropriate one of a plurality of functions is selected in a user interface of the microwave oven 10, the magnetron 50 is activated thereby coupling microwave energy to the cooking cavity 14 of microwave oven 10 via waveguide 52.

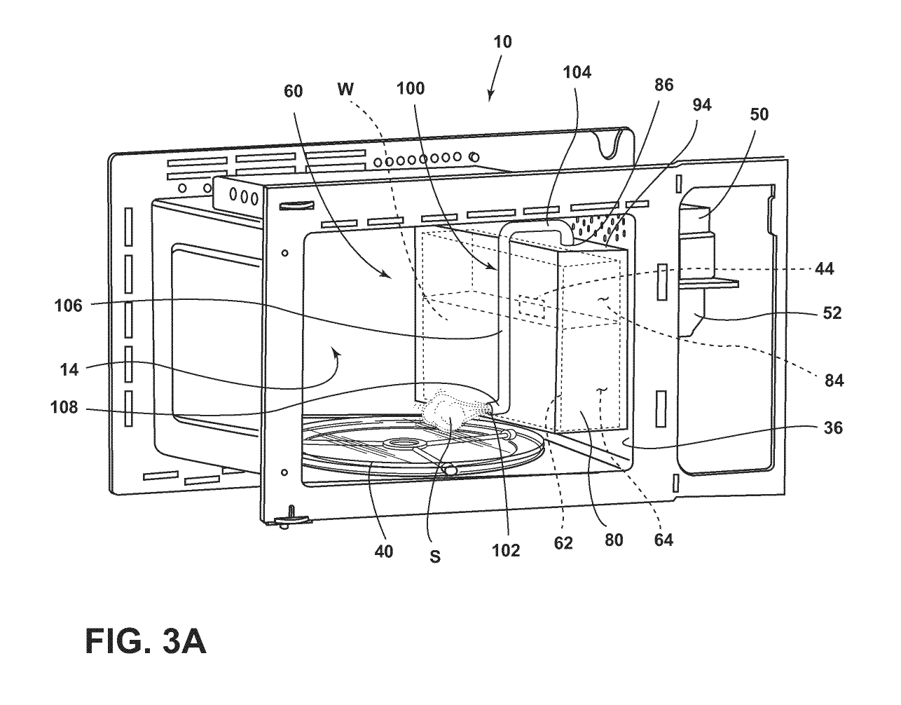

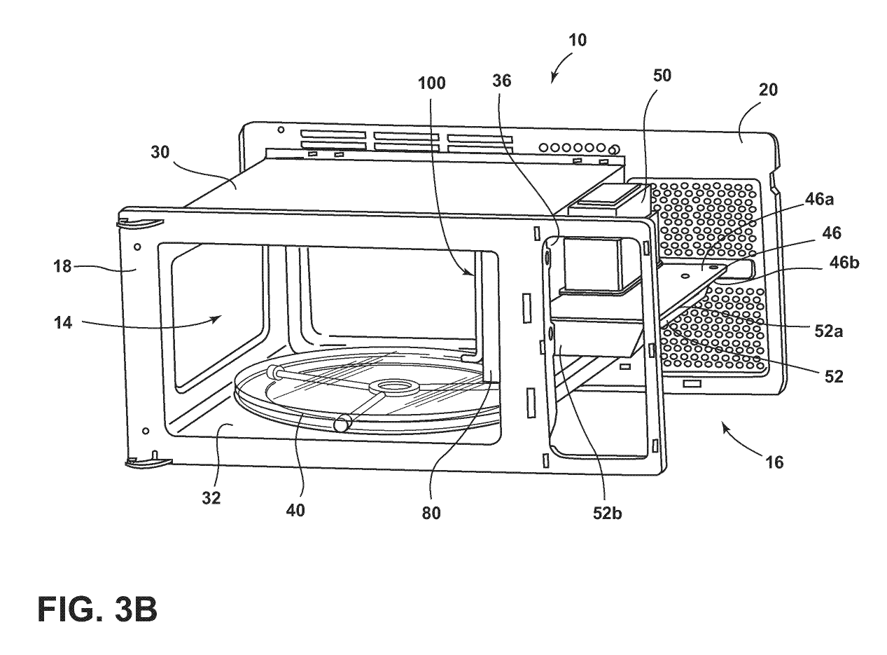

Referring now to FIG. 2, top wall 30 of the cooking cavity 14 is shown exploded away from the microwave oven 10 to reveal various components also exploded away from the housing 12 of the microwave oven 10. The various components include magnetron 50, described above, and a steam generating device 60. The steam generating device 60 includes a water tank 62 having a cavity portion 64 and an open top 66, wherein a sealing member 68 and a cover 70 are positioned in assembly. The water tank 62, sealing member 68 and cover 70 are configured to be received within a casing 80 which is contemplated to be made of a material that is impenetrable to microwave energy, such as a metallic material. The casing 80, as shown in FIG. 2, is generally a rectangular shaped casing having an open side 82 and cavity portion 84 in which the water tank 62 is received. An outlet 86 is disposed through the casing 80 and is configured to receive a pipe member 100 which is configured to deliver steam to the cooking cavity 14 of the microwave oven 10, as further described below. As further show in FIG. 2, the casing 80 includes a plurality of engagement members 88a-88d which outwardly extend from sidewalls 90, 92. The engagement members 88a-88d comprise downwardly extending hook members, which are configured to be received and supported on sidewall 36 at mounting apertures 42a-42d within the cooking cavity 14, as further described below. The casing 80 further includes a top wall 94, a bottom wall 96 and exterior wall 98, wherein the exterior wall 98 is disposed opposite from the open side 82. In assembly, the water tank 62 and cover 70 are configured to be closely received within the cavity 84 of the casing 80. As further shown in FIG. 2, the cover 70 includes a generally planar body portion 72, an upper back portion 74 and a plurality of upstanding rib members 76 disposed therebetween. In operation, the cover 70 is configured to allow steam generated from water stored in the cavity 64 of the water tank 62 to escape into the casing 80, from which the steam exits through the outlet 86 disposed on the top wall 94 of the casing 80, and finally proceeds through the pipe member 100 and into the cooking cavity 14 through steam inlet 102. As shown in FIG. 2, the pipe member 100 includes a first generally horizontal portion 104 which substantially runs along the top wall 94 of the casing 80, and a second substantially vertical portion 106 which generally runs along the exterior wall 98 of the casing 80. A third portion 108 directs steam towards the cooking cavity 14 at a lower portion of the cooking cavity 14, such that the steam is propelled into the cooking cavity 14 from steam outlet 102 adjacent the cooking tray 40 where a food item to be cooked is generally disposed. This configuration is better shown and described below with reference to FIG. 3A.

Referring now to FIGS. 3A and 3B, the steam generating device 60 is shown coupled to sidewall 36 of the microwave oven 10. Thus, the steam generating device 60 is a modular or add-on feature to the microwave oven 10, such that the steam generating device 60 can be used with virtually any existing microwave oven. As discussed above, the water tank 62 is shown disposed within the cavity portion 84 of the casing 80. The cavity portion 64 of the water tank 62 is shown with a volume of water W disposed therein. The casing 80 is coupled to sidewall 36 in such a manner that the casing 80 completely covers microwave inlet 44, shown in FIG. 1, disposed on side wall 36. In this way, the casing 80 completely covers the access for microwaves into the cooking cavity 14. The casing 80, as noted above, may be made of a metallic material which provides for a cavity in which microwaves are introduced, reflected and microwave energy is concentrated, such that the water W held in the water tank 62 can heat up faster and generate moisture for producing steam. The microwave concentrating configuration of the casing 80 provides accelerated steam production as compared to known systems where microwaves are dispersed throughout the cooking cavity 14. The casing 80 not only covers the microwave inlet 44 of sidewall 36, but also prevents the microwaves from irradiating into the cooking cavity 14 as the casing 80 is made of a microwave impenetrable material. In this way, when the casing 80 is coupled to side wall 36 over microwave inlet 44, the microwave oven 10 is configured to cook a food item solely by steam generated from the steam generating device 60, rather than cooking the food item using conventional microwaves.

As specifically shown in FIG. 3A, the steam generating device 60 is producing steam S from outlet 102 of pipe member 100. Thus, as shown in FIG. 3A, the magnetron 50 has been energized to produce microwaves which are guided by the waveguide 52 to microwave inlet 44, shown in FIG. 1, which provides microwaves into the casing 80 through open side 82 for reflection and concentration therein. With the water tank 62 disposed within the casing 80, the water W is heated to produce steam which rises and exits out of steam outlet 86 disposed in the top wall 94 of the casing 80 which then proceeds through portions 104, 106 and 108 of pipe member 100 to eventually reach outlet 102 of pipe member 100. As shown in FIG. 3A, the steam S generated by the steam generating device 60 is dispensed at a lower portion of the cooking cavity 14 for cooking a food item disposed on cooking tray 40. Again, in the configuration shown in FIG. 3A, the microwave oven 10 is configured to cook a food item within the cooking cavity 14 using steams only. As shown in FIG. 3B, end 52b of waveguide 52 is disposed adjacent to casing 80 on an opposite side of sidewall 36. Thus, the waveguide 52 directs microwaves produced by the magnetron 50 directly towards the casing 80, as described above, and microwaves are not directed to any other access point of the cooking cavity.

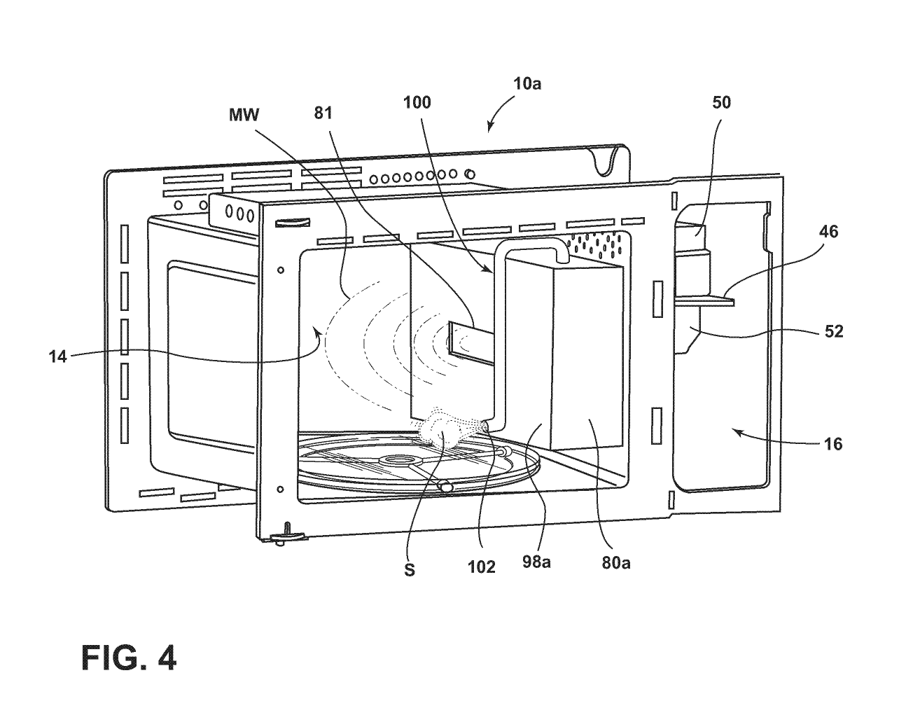

Referring now to FIG. 4, a microwave oven 10a, according to another embodiment, includes a metal casing 80a, which functions in a similar manner as compared to casing 80 described above. In the embodiment shown in FIG. 4, the casing 80a further includes a microwave outlet 81 in the form of an aperture disposed on exterior side 98a of casing 80a. While casing 80, described above with reference to FIGS. 3A and 3B, contained and concentrated microwaves within a cavity portion thereof, casing 80a includes microwave outlet 81 which allows microwaves, shown in FIG. 4 in dashed lines designated MW, to irradiate into the cooking cavity 14 for cooking a food item disposed therein. Thus, when using casing 80a with the steam generating device 60 of the present concept, a food item disposed within the cooking cavity 14 of the microwave oven 10a is cooked using both microwaves MW and steam S as shown in FIG. 4. While the casing 80a includes microwave outlet 81, the microwave outlet 81 is appropriately sized on the exterior wall 98a, such that microwaves from magnetron 50 are still concentrated within the casing 80a to provide steam S delivered from pipe member 100 and outlet 102. In this way, the casing 80a still allows for concentration of microwaves therein, and further allows for microwaves to irradiate to the cooking cavity 14 for cooking a food item placed therein.

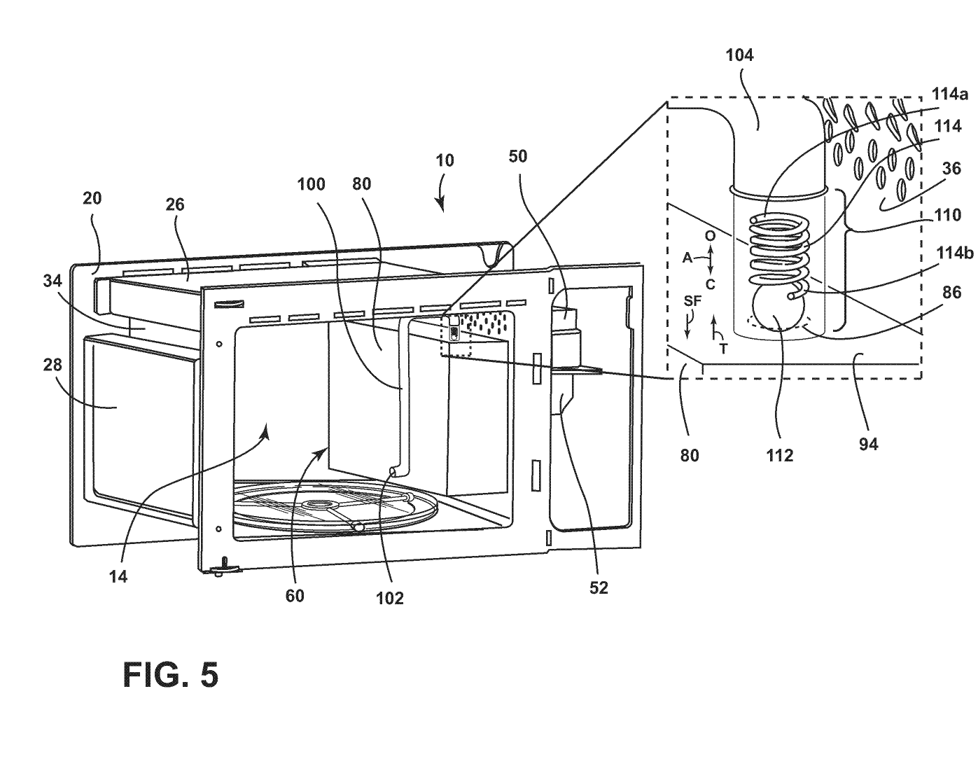

Referring now to FIG. 5, a pressure control apparatus 110 is shown coupled to the steam generating device 60. The pressure control apparatus 110 is configured to control the introduction of steam S into the cooking cavity 14 of the microwave oven 10. As noted above, the pipe member 100 is in communication with a steam outlet 86 disposed on the top wall 94 of the casing 80. In assembly, the pipe member 100 houses the pressure control apparatus 110. As shown, the pressure control apparatus 110 includes an actuating member 112 which is operable between open and closed positions O, C relative to steam outlet 86 along a substantially vertical path indicated by arrow A. The pressure control apparatus 110 further includes a biasing mechanism 114 which is coupled to the pipe member 100 at a first end 114a and abuts the actuating member 112 at a second end 114b. The biasing mechanism 114 is configured to bias the actuating member 112 towards the closed position C. In the closed position C, as shown in FIG. 5, the actuating member 112 is a ball-like feature that is fully received in steam outlet 86 to close steam outlet 86. As further shown in FIG. 5, the biasing mechanism 114 is in the form of a coil spring having a spring force, indicated by arrow SF, that is a downward force realized on actuating member 112. In use, the biasing mechanism 114 is configured to be overcome by a threshold force T of steam S acting on the actuating member 112, such that the actuating member 112 moves to the open position O to provide steam to the cooking cavity 14 through the pipe member 100. In this way, the casing 80 provides a microwave concentrating cavity to heat water W provided in the water tank 62 which produces steam as described above. The steam begins to build pressure within the casing 80 and once the pressure reaches a threshold force T which exceeds the spring force SF of the biasing mechanism 114, the actuating member 112 moves to the open position O to release the steam from the casing 100. In this way, the steam is propelled into the cooking cavity 14 only after a specific pressure is realized within the steam generating device 60. It is further contemplated that the casing 80 may include an aperture, such as microwave outlet 81 described above with reference to FIG. 4, for cooking a food item using high pressure steam and microwaves within the cooking cavity 14.

It will be understood by one having ordinary skill in the art that construction of the described concept and other components is not limited to any specific material. Other exemplary embodiments of the concept disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the concept as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present concept. The exemplary structures and processes disclosed herein are for illustrative purposes and are not to be construed as limiting.

It is also to be understood that variations and modifications can be made on the aforementioned structures and methods without departing from the concepts of the present concept, and further it is to be understood that such concepts are intended to be covered by the following claims unless these claims by their language expressly state otherwise.

1-15. (canceled)

16. A steam generating device for use with a microwave oven, the microwave oven including a housing having a cooking cavity and a component compartment separated by a sidewall of the cooking cavity, a microwave generating device disposed in the component compartment and configured to irradiate microwaves into the cooking cavity through a microwave inlet disposed on the sidewall of the cooking cavity, the steam generating device comprising:
a casing made of a material impenetrable to microwave energy defining a cavity, the casing having a steam outlet and configured to be removably coupled to the sidewall of the cooking cavity over the microwave inlet; and
a water tank having an open top and a cavity configured to hold a volume of water, the water tank received in the cavity of the casing.

17. The steam generating device of claim 16, wherein the casing further includes an open side which opens into the cavity.

18. The steam generating device of claim 17, wherein the open side of the cavity of the casing is aligned with the microwave inlet of the microwave oven when the casing is coupled to the sidewall of the cooking cavity to allow microwaves into the cavity of the casing.

19. The steam generating device of claim 18, wherein the cavity of the casing defines a microwave concentrating cavity that retains the microwaves within the cavity of the casing.

20. The steam generating device of claim 16, wherein the casing retains the microwaves within the cavity of the casing and blocks the microwaves from irradiating into the cooking cavity.

21. The steam generating device of claim 16, wherein the casing includes a microwave outlet for permitting passage of microwaves into the cooking cavity.

22. The steam generating device of claim 21, wherein the casing delivers both steam and microwaves to the cooking cavity from the steam outlet and microwave outlet, respectively.

23. The steam generating device of claim 22, further including:
a pipe member coupled to the casing at the steam outlet, the pipe member configured to direct steam to the cooking cavity of the microwave oven for cooking a food substrate placed therein.

24. The steam generating device of claim 23, wherein the pipe member directs steam to a lower portion of the cooking cavity.

25. A microwave oven, comprising:
a cooking cavity having a sidewall with a microwave inlet disposed thereon;
a microwave generating device for selectively supplying microwaves to the cooking cavity through the microwave inlet; and
a steam generating device for introducing steam into the cooking cavity, including a water tank received in a casing made of a microwave impenetrable material and having an open side, the casing being removably coupled to the sidewall of the cooking cavity and including a steam outlet opening into the cooking cavity, wherein the casing covers the microwave inlet as coupled to the sidewall of the cooking cavity.

26. The microwave oven of claim 25, wherein the sidewall of the cooking cavity includes one or more mounting apertures.

27. The microwave oven of claim 26, wherein the casing includes one or more engagement members extending outwardly from the open side, the one or more engagement members configured to engage the one or more mounting apertures of the sidewall of the cooking cavity.

28. The microwave oven of claim 25, further including:
a pipe member in communication with the steam outlet of the casing, the pipe member configured to deliver steam to the cooking cavity of the microwave oven for cooking a food substrate placed therein.

29. The microwave oven of claim 28, wherein the casing includes a microwave outlet for permitting passage of microwaves into the cooking cavity.

30. A microwave oven, comprising:
a cooking cavity having a sidewall with a microwave inlet disposed thereon;
a microwave generating device capable of producing microwaves and disposed on an opposite side of the sidewall relative to the cooking cavity; and
a steam generating device for introducing steam into the cooking cavity, including a water tank received in a microwave impenetrable casing, the casing having a steam outlet and being removably coupled to the sidewall of the cooking cavity over the microwave inlet, wherein the casing receives microwaves from the microwave generating device through the microwave inlet and blocks the microwaves from entering the cooking cavity.

31. The microwave oven of claim 30, including a pressure control apparatus coupled to the steam generating device, the pressure control apparatus configured to control the introduction of steam into the cooking cavity.

32. The microwave oven of claim 31, including:
a pipe member in communication with the steam outlet of the casing, wherein the piper member houses the pressure control apparatus and further, wherein the pipe member is configured to direct steam to the cooking cavity of the microwave oven for cooking a food substrate placed therein.

33. The microwave oven of claim 31, wherein the pressure control apparatus includes an actuating member operable between open and closed positions relative to the steam outlet and further includes a biasing mechanism biasing the actuating member towards the closed position.

34. The microwave oven of claim 32, wherein the biasing mechanism is configured to be overcome by a threshold force of steam acting on the actuating member, such that the actuating member moves to the open position to provide steam to the cooking cavity.

35. The microwave oven of claim 30, wherein the sidewall of the cooking cavity includes one or more mounting apertures, and further wherein the casing includes an open side and one or more engagement members extending outwardly from the open side, the one or more engagement members configured to engage the one or more mounting apertures of the sidewall of the cooking cavity.
